(19) United States
(12) Patent Application Publication
(10) Pub. No.: US 2022/0379956 A1
(43) Pub. Date: Dec. 1, 2022

(54) System and Method for Controlling Steering Torque of a Steering System of a Vehicle

(71) Applicant: ZF Friedrichshafen AG, Friedrichshafen (DE)

(72) Inventor: Daniel E. Williams, Carmel, IN (US)

(21) Appl. No.: 17/331,909

(22) Filed: May 27, 2021

(51) Int. Cl. B62D 6/00; B62D 5/00

(52) U.S. Cl. CPC B62D 6/008; B62D 5/006

(57) ABSTRACT

A system for controlling steering torque of a steering system of a vehicle may include a steering wheel, a steering shaft rotatably fixed to the steering wheel, a steering actuator controllable to apply a steering torque associated with a perceived stiffness to the steering shaft, and one or more driving style sensors provided in association with the steering wheel, where the driving style sensors generate data indicative of a grip style of a driver on the steering wheel. The system may further include a computing device communicatively coupled to the one or more driving style sensors and the steering actuator. The computing device may determine a driving style of the driver based at least in part on the data generated by the one or more driving style sensors and control an operation of the steering actuator to adjust the perceived stiffness based at least in part on the driving style.

### FIELD OF THE INVENTION

The present subject matter relates generally to steering systems of vehicles and, more particularly, to controlling steering torque of a steering system of a vehicle based on a driver's driving style.

### BACKGROUND OF THE INVENTION

Conventional vehicles generally include power assist steering systems that provide torque to a steering wheel to help a driver turn a vehicle, where the torque is variable based on the speed of the vehicle. For instance, as speed increases, it typically becomes easier for a driver to turn a steering wheel to steer the vehicle, so less torque is needed from the power assist steering system. Conversely, as speed decreases, it typically becomes more difficult for a driver to turn the steering wheel to steer the vehicle, so more torque is needed from the power assist steering system. The torque from the power assist steering system provides a torque to a steering shaft coupled between the steering wheel and the vehicle wheels, as such, a driver may perceive a change in stiffness when turning the steering wheel as the torque varies.

However, depending on a driving style of a driver, the stiffness perceived from the average assistance torque may be undesirable, particularly for high speed travel. For instance, less passive drivers may make more corrections to a heading of the vehicle and may want a higher perceived stiffness when making corrections to feel more in control. Similarly, more passive drivers may make fewer corrections to the heading of the vehicle and may want a lower perceived stiffness when making corrections so that it feels easier to make corrections. Accordingly, systems and methods for controlling steering torque of a steering system of a vehicle based on a driver's driving style would be welcomed in the technology.

### BRIEF DESCRIPTION OF THE INVENTION

Aspects and advantages of the invention will be set forth in part in the following description, or may be apparent from the description, or may be learned through practice of the invention.

The present subject matter relates generally to systems and methods for controlling steering torque of steering systems of vehicles. In certain example embodiments, the systems and methods may determine a driving style of a driver and control the steering torque provided by the steering systems based on the determined driving style.

In an example embodiment, a system for controlling steering torque of a steering system of a vehicle includes a steering wheel and a steering shaft rotatably fixed to the steering wheel, where rotation of the steering shaft causes rotation of wheels of the vehicle about a steering axis. The system may further include a steering actuator controllable to apply a steering torque to the steering shaft, the steering torque being associated with a perceived stiffness. Moreover, the system may include one or more driving style sensors provided in association with the steering wheel, with the driving style sensors being configured to generate data indicative of a grip style of a driver on the steering wheel. Additionally, the system may include a computing device communicatively coupled to the one or more driving style sensors and the steering actuator, where the computing device is configured to determine a driving style of the driver based at least in part on the data generated by the one or more driving style sensors and to control an operation of the steering actuator to adjust the perceived stiffness based at least in part on the driving style.

In a first example aspect, the data generated by the one or more driving style sensors indicates at least one of a number of contact points between the driver and the steering wheel, a position of the contact points between the driver and the steering wheel, or a grip force applied by the driver on the steering wheel.

In a second example aspect, determining the driving style of the driver includes determining that the driving style is relaxed when at least one of the number of contact points is less than two, the position of the contact points is below a middle of the steering wheel, or the grip force is less than a grip force threshold. Determining the driving style of the driver further includes determining that the driving style is aggressive when at least one of the number of contact points is equal to or greater than two, when the position of the contact points is at or above the middle of the steering wheel, or the grip force is equal to or greater than the grip force threshold.

In a third example aspect, determining the driving style of the driver includes applying the at least one of the number of contact points, the position of the contact points, or the grip force applied by the driver on the steering wheel to one or more algorithms.

In a fourth example aspect, the system further includes one or more shaft sensors configured to generate data indicative of at least one of a total torque applied to the steering shaft or an angular displacement of the steering shaft, where determining the driving style of the driver includes determining the driving style of the driver based at least in part on the data generated by the one or more driving style sensors and the data generated by the one or more shaft sensors.

In a fifth example aspect, controlling the operation of the steering actuator to adjust the perceived stiffness based at least in part on the driving style includes controlling the operation of the steering actuator to increase the steering torque to above an average assistive torque when the driving style is relaxed to reduce the perceived stiffness and controlling the operation of the steering actuator to decrease the steering torque to below the average assistive torque when the driving style is aggressive to increase the perceived stiffness.

In a sixth example aspect, the system further includes at least one driving assistance sensor configured to generate data indicative of a position of the vehicle relative to a lane boundary. The computing device may be communicatively coupled to the at least one driving assistance sensor, where the computing device is further configured to automatically control the operation of the steering actuator to adjust a guiding torque applied by the steering actuator on the steering shaft based at least in part on the position of the vehicle relative to the lane boundary and the driving style. For instance, automatically controlling the operation of the steering actuator based at least in part on the position of the vehicle relative to the lane boundary and the driving style includes controlling the operation of the steering actuator to decrease the guiding torque when the driving style is a relaxed driving style and to increase the guiding torque when the driving style is an aggressive driving style.

In a seventh example aspect, the one or more driving style sensors includes one or more pressure transducers on the steering wheel, with the one or more pressure transducers being configured to generate an electrical signal proportional to a grip force applied to the steering wheel.

In an eighth example aspect, the system further includes a speed sensor configured to generate data indicative of a speed of the vehicle, with the computing device being configured to control the operation of the operation of the steering actuator to adjust the perceived stiffness based at least in part on the driving style when the speed of the vehicle exceeds a speed threshold.

In a ninth example aspect, a method for controlling steering torque of a steering system of a vehicle is provided where the steering system includes a steering wheel, a steering shaft rotatably fixed to the steering wheel, and a steering actuator controllable to apply a steering torque to the steering shaft, the steering torque being associated with a perceived stiffness. The method may be configured to implement the same processes of the system. For instance, the method may include receiving, by one or more computing devices, data indicative of a grip style of a driver from one or more driving style sensors provided in association with the steering wheel. The method may further include determining, by the one or more computing devices, a driving style of the driver based at least in part on the data indicative of the grip style. Additionally, the method may include controlling, by the one or more computing devices, an operation of the steering actuator to adjust the perceived stiffness based at least in part on the driving style.

Each of the example aspects recited above may be combined with one or more of the other example aspects recited above in certain embodiments. For instance, all of the nine example aspects recited above may be combined with one another in some embodiments. As another example, any combination of two, three, four, or five of the nine example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a side, elevation view of a vehicle with a sensor system according to an example embodiment of the present subject matter.

FIG. 2 is a schematic view of a steering system suitable for use with the example vehicle of FIG. 1.

FIG. 3 is a schematic view of an example control system of the vehicle of FIG. 1.

FIG. 4 is a flow diagram of a method for controlling steering torque of a steering system of a vehicle.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

Example embodiments of the present disclosure are directed to systems and methods for controlling steering torque of a steering system of a vehicle. Specifically, a steering system of a vehicle may include a steering actuator configured to provide steering torque to a steering shaft coupled between a steering wheel and a steering gear to help turn the steering gear and, thus, turn the vehicle. One or more driving style sensors may be provided in association with a steering wheel of the vehicle to determine the grip style and force applied by the driver. Additionally, one or more shaft sensors may be provided in association with the steering shaft to determine a total torque applied to the steering shaft by the driver and the steering actuator and/or an angular speed of the steering shaft. A driving style of the driver may be determined based on the data from the driving style sensors and, optionally, the shaft sensors. For instance, data from the driving style sensors and the shaft sensors may be used to determine if a driver is using one or both hands, where the driver is holding the steering wheel, how tightly the driver is gripping the steering wheel, and the speed, frequency, and/or magnitude of torque corrections that an operator makes. Based on the determined driving style, the steering torque provided by the steering actuators may be adjusted to better suit the driver, particularly when the vehicle is traveling at highway speeds. For instance, steering torque may be increased for less aggressive drivers, as less aggressive drivers may perceive a lower steering stiffness with more steering torque, which may make the vehicle feel easier to steer to a relaxed driver. Conversely, steering torque may be decreased for more aggressive drivers, as more aggressive drivers may perceive a higher steering stiffness with lower steering torque, which may make aggressive drivers feel that they have more control.

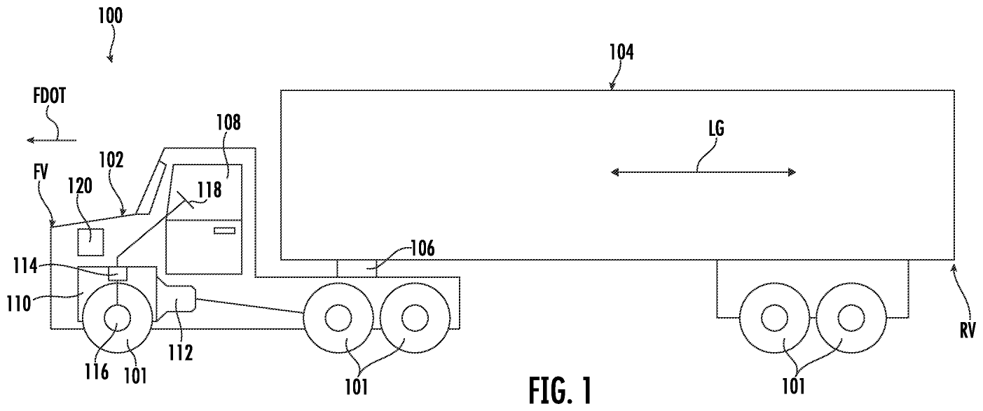

FIG. 1 illustrates a side, elevation view of commercial vehicle 100. As shown in FIG. 1, commercial vehicle 100 includes a tractor 102 and a trailer 104 and is generally referred to as a “tractor-trailer truck.” Commercial vehicle 100 is provided as an example only. For instance, commercial vehicle 100 may include one, two, or more additional trailers in alternative example embodiments. In addition, while described below in the context of commercial vehicle 100, it will be understood that the present subject matter may be used in or with any other suitable vehicle, including passenger vehicles, such as cars, vans, trucks, etc., or commercial vehicles, such as buses, box trucks, farm vehicles, construction vehicles, etc., in other example embodiments.

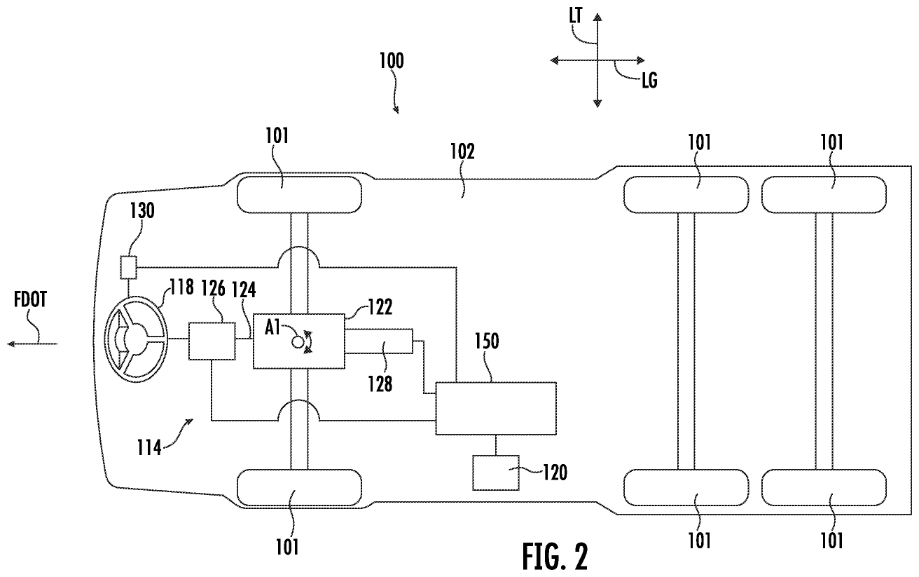

Commercial vehicle 100 may define a longitudinal direction LG and a lateral direction LT (FIG. 2), which are perpendicular to each other. A front portion FV of commercial vehicle 100 and a rear portion RV of commercial vehicle 100 may be spaced apart from each other along the longitudinal direction LG. Thus, commercial vehicle 100 may extend between the front and rear portions FV, RV of commercial vehicle 100 along the longitudinal direction LG. Conversely, side portions of commercial vehicle 100 may be spaced apart from each other along the lateral direction LT.

Tractor 102 is pivotally connected to trailer 104 via a hitch 106 and is operative to tow trailer 104. Various items for transport may be stored within trailer 104. In alternative example embodiments, trailer 104 may be open, e.g., a flat bed, depending on items stored on trailer 104. Tractor 102 may include various components for towing trailer 104, including a motor system 110, a transmission system 112, a steering system 114, a braking system 116, etc. A rider may sit within a cab 108 of tractor 102 during operation. However, commercial vehicle 100 need not include seating within cab 108 or any cab 108 at all in certain example embodiments, e.g., when commercial vehicle 100 is configured for fully automated driving.

In general, motor system 110, transmission system 112, steering system 114, and braking system 116 may be configured in any conventional manner. For example, motor system 110 may generally include a suitable prime mover, such as an electric motor or internal combustion engine, that is operative to propel commercial vehicle 100. Motor system 110 may be disposed within tractor 102 and may be connected to transmission system 112. Transmission system 112 is disposed within power flow between motor system 110 and wheels 101 of commercial vehicle 100. Transmission system 112 is operative to provide various speed and torque ratios between an input and output of the transmission system 112. Thus, e.g., transmission system 112 may provide a mechanical advantage to assist propulsion of commercial vehicle 100 by motor system 110. Steering system 114 is operable to adjust the direction of travel of commercial vehicle 100. For instance, steering system 114 may be coupled to the front wheels 101 of commercial vehicle 100 and be operatable to turn the front wheels 101 in response to a driver of commercial vehicle turning a steering device 118 (e.g., a steering wheel) within cab 108 and/or operation of a prime mover (e.g., steering actuator 126) within steering system 114. Braking system 116 is operable to decelerate commercial vehicle 100. For instance, braking system 116 may include friction brakes configured to selectively reduce the rotational velocity of wheels 101. Braking system 116 may also be configured to as a regenerative braking system that converts kinetic energy of wheels 101 into electric current. Operation of motor system 110, transmission system 112, steering system 114, and braking system 116 is well known to those skilled in the art and not described in extensive detail herein for the sake of brevity.

Commercial vehicle 100 also includes one or more sensors 120 for determining a speed of vehicle 100. Sensor(s) 120 provide data, such as electronic signals, indicative of vehicle speed. It should be appreciated that sensor(s) 120 may be configured as any suitable sensor for detecting the speed of commercial vehicle 100. For instance, each sensor 120 may include at least one of a GPS-based sensor(s), an inductive sensor(s), a rotational sensor(s), and/or the like.

FIG. 2 illustrates a schematic view of steering system 114 suitable for use with commercial vehicle 100. In general, steering system 114 includes steering wheel 118 connected to a steering gear 122 by a steering shaft 124 such that rotation of steering wheel 118 causes rotation of steering shaft 124 and of steering gear 122, which changes a heading angle of the steering wheels relative to a forward direction of travel FDOT (e.g., rotates steering wheels 101 about a steering axis A1). Moreover, the steering system 114 includes a steering actuator 126 connected to steering shaft 124. Steering actuator 126 is configured to apply a torque to assist a driver in rotating steering shaft 124. For instance, the amount of torque applied by steering actuator 126 may be varied based on a speed of vehicle 100. The total force or torque acting on the steering shaft 124 (e.g., by steering actuator 126 and a driver) may be measured using one or more shaft sensors 128. The shaft sensor(s) 128 may include a transducer(s) configured to output an electrical signal proportional to the dynamic or rotary torque applied to the steering shaft 124. Alternatively, or additionally, shaft sensor(s) 128 may include angular position sensors for detecting the angular position of steering shaft 124, where the angular position of steering shaft 124 (e.g., from a neutral position) is indicative of the torque acting on steering shaft 124.

The steering torque applied by steering actuator 126 provides a desired steering feel and/or steering torque for the driver. However, the steering torque is typically selected based on only certain average driving factors, such as the speed of vehicle 100, to make it easier for a driver to steer. As such, a perceived stiffness associated with the steering torque may be less desirable to different drivers having different driving styles. Accordingly, steering system 114 further includes one or more driving style sensors 130 configured to generate data indicative of a driving style of a driver. Driving style sensor(s) 130 may, for example, include pressure transducer(s), such as piezo-electric sensor(s), on steering wheel 118 configured to output an electric signal that is indicative of (e.g., proportional to) a grip force applied to steering wheel 118 by a driver. Each of driving style sensor(s) 130 may be associated with a particular region or position on steering wheel 118 such that a number and location of points contact between the driver and steering wheel 118 can be determined. As will be described below in greater detail, a control system may determine the grip force applied to steering wheel 118 based at least in part on the data from driving style sensor(s) 130 and, in response, determine a driving style of the driver of vehicle 100. Thereafter, the disclosed control system may further be configured to control an operation of the steering actuator 126 based at least in part on the determined driving style and a speed of the vehicle 100.

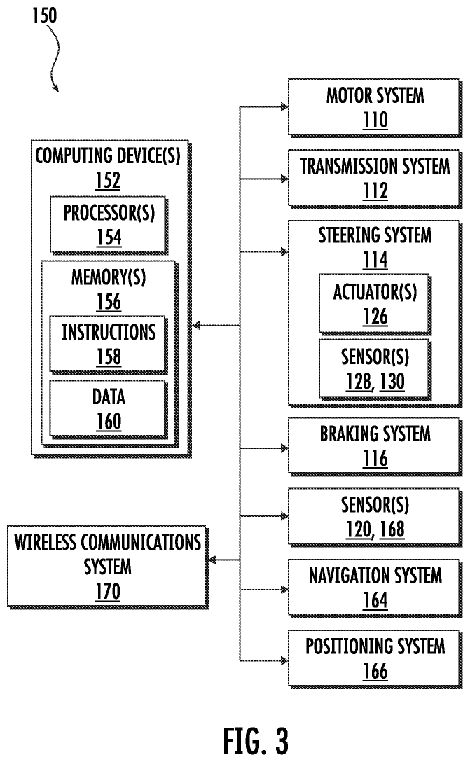

FIG. 3 is a schematic view of certain components of a control system 150 suitable for use with commercial vehicle 100. In general, control system 150 is configured to control operation of steering system 114 of commercial vehicle 100 and components therein. For instance, as shown in FIG. 3, control system 150 includes one or more computing devices 152 with one or more processors 154 and one or more memory devices 156 (hereinafter referred to as “memories 156”). In certain example embodiments, control system 150 may correspond to an electronic control unit (ECU) of tractor 102. The one or more memories 156 stores information accessible by the one or more processors 154, including instructions 158 that may be executed and data 160 usable by the one or more processors 154. The one or more memories 156 may be of any type capable of storing information accessible by the one or more processors 154, including a computing device-readable medium. The memory is a non-transitory medium, such as a hard-drive, memory card, optical disk, solid-state, tape memory, or the like. The one or more memories 156 may include different combinations of the foregoing, whereby different portions of the instructions and data are stored on different types of media. The one or more processor 154 may be any conventional processors, such as commercially available CPUs. Alternatively, the one or more processors 154 may be a dedicated device, such as an ASIC or other hardware-based processor.

Instructions 158 may be any set of instructions to be executed directly (such as machine code) or indirectly (such as scripts) by the one or more processors 154. For example, the instructions 158 may be stored as computing device code on the computing device-readable medium of the one or more memories 156. In that regard, the terms “instructions” and “programs” may be used interchangeably herein. Instructions 158 may be stored in object code format for direct processing by the processor or in any other computing device language, including scripts or collections of independent source code modules that are interpreted on demand or compiled in advance. Data 160 may be retrieved, stored, or modified by the one or more processors 154 in accordance with the instructions 158. For instance, data 160 of the one or more memories 156 may store information from sensors, including sensors 120, 128, 130. In FIG. 3, the processor(s) 154, memory(ies) 156, and other elements of computing device(s) 152 are shown within the same block. However, computing device(s) 152 may actually include multiple processors, computing devices, and/or memories that may or may not be stored within a common physical housing. Similarly, the one or more memories 156 may be a hard drive or other storage media located in a housing different from that of the processor(s) 154. Accordingly, computing devices 152 will be understood to include a collection of processor(s) and one or more memories that may or may not operate in parallel.

Control system 150, e.g., the computing device(s) 152, may form a steering computing system for commercial vehicle 100. The steering computing system may be configured for communicating with various components of commercial vehicle 100 in order to perform steering operations. For example, control system 150 may be in operative communication with various systems of the vehicle, including motor system 110, transmission system 112, steering system 114, and braking system 116. For instance, control system 150 may particularly be in operative communication with an engine control unit (ECU) 111 (not shown) of motor system 110 and a transmission control unit (TCU) 113 (not shown) of transmission system 112. Control unit 150 may also be in operative communication with other systems of commercial vehicle 100, including a lighting/warning system (for controlling horns, headlights, taillights, and/or turn signals of commercial vehicle 100) (not shown), a navigation system 164 (for navigating commercial vehicle 100 to a destination), and/or a positioning system 166 (for determining a current location (e.g., GPS coordinates) of commercial vehicle 100).

Control system 150, e.g., the computing device(s) 152, may particularly be configured to control the steering assist of vehicle 100 by controlling the various components of steering system 114. For instance, control system 150 may use data from speed sensor(s) 120, shaft sensor(s) 128, and driving style sensor(s) 130 to control steering actuator(s) 126 of steering system 114. Particularly, computing devices 152 may use data from speed sensor(s) 120 (and/or motor system 110, transmission system 112, etc.) to determine the current speed of vehicle 100, data from shaft sensor(s) 128 to detect torque applied to steering shaft 124 by an operator and steering actuator(s) 126, and data from driving style sensor(s) 130 to determine a driving style of the driver. During travel, computing devices 152 may then selectively increase or decrease steering torque provided by steering actuator(s) 126 based at least in part on the driving style of the driver and the speed of the vehicle, particularly at high speeds.

Data from shaft sensor(s) 128 and driving style sensor(s) 130 may be used to determine a driving style of a driver. For instance, the data from driving style sensor(s) 130 may be indicative of a number of points of contact or contact points between a driver and steering wheel 118 (whether a driver has one or both hands on steering wheel 118), the locations of points of contact between a driver and steering wheel 118 (e.g., whether the driver has hand(s) at the top, middle, or bottom of steering wheel 118), how tightly the driver is gripping steering wheel 118 (e.g., grip force), and/or how frequently the driver adjusts their grip (e.g., switches number and/or location of points of contact). Similarly, data from shaft sensor(s) 128 may be used to determine the speed, frequency, and/or magnitude at which a driver performs steering corrections (e.g., how fast, how often, and/or how much torque an operator applies). The control system 150 may monitor driving style parameters (e.g., number of points of contact, locations of point(s) of contact, grip force, frequency of grip adjustment, and/or speed, frequency, and/or magnitude of corrective torque) over a certain distance, time, or speed threshold. For instance, control system 150 may monitor the driving style parameters during each trip to accurately identify the driving style of a current driver, cumulatively based on highway driving, and/or the like. It should be appreciated that while only two driving styles (relaxed or aggressive) will be discussed herein for the sake of example, any suitable number of driving styles may be established. For instance, a range of driving styles may be established between the relaxed or aggressive driving styles. Further, it should be appreciated that the speed threshold may correspond to a highway speed threshold, such as 55 miles per hour (mph), 60 mph, 65 mph, and/or the like. Alternatively, or additionally, control system 150 may monitor braking system 116 to determine that vehicle 100 has been driven continuously without coming to a full or near stop for a threshold period of time, which indicates that vehicle 100 is being driven on a highway or in highway-like conditions.

In some embodiments, control system 150 compares the monitored driving style parameters to one or more respective thresholds to determine the overall driving style of the driver. For instance, control system 150 may monitor the driving style parameters over a given period of high-speed travel to determine that a driver is a relaxed driver if at least one of the following conditions or one or more predetermined combinations of the following conditions are met: less than two points of contact between the driver and steering wheel 118 are usually detected, the points of contact are typically lower on the steering wheel (e.g., below a middle of steering wheel 118), the grip force is usually less than a grip force threshold, the speed of corrective torques are usually less than a speed threshold, the number or frequency of corrective torques are usually less than a frequency threshold, and/or a magnitude of the corrective torques are usually less than a magnitude threshold. Similarly, control system 150 may monitor the driving style parameters to determine that a driver is a nervous or aggressive driver if at least one of the following conditions or one or more predetermined combinations of the following conditions are met: two or more points of contact between the driver and steering wheel 118 are usually detected, the points of contact are typically higher on the steering wheel 118 (e.g., at or above a middle of steering wheel 118), the grip force is usually equal to or greater than a grip force threshold, the speed of corrective torques are usually greater than a speed threshold, the number or frequency of corrective torques are usually equal to or greater than a frequency threshold, and/or a magnitude of the corrective torques are usually equal to or greater than a magnitude threshold.

Alternatively, or additionally, in some embodiments control system 150 applies the monitored driving style parameters to one or more algorithms to determine the overall driving style of the driver. The algorithms(s) give different weights to the monitored driving style parameter(s) in order to determine a value indicative of the driving style of the driver. A reference table may additionally be saved in the memory 156 that correlates driving style values determined using the algorithm(s) and different driving styles. The algorithm(s) may be predetermined and stored within memory 156 or may be determined and/or provided to the control system 150 in any other suitable way.

In response to determining the driving style, control system 150 may be configured to control the operation of steering system 114. For instance, if the driving style is determined as relaxed while the speed of vehicle 100 is considered high-speed or highway speed (e.g., above or exceeds a speed threshold), control system 150 may control the steering actuator(s) 126 to provide more steering torque than an average assistive torque provided based on average driving such that a small torque input provided by a driver yields a larger rotational displacement of steering wheel 118 than when the average assistive torque is applied. By providing more steering torque, lower artificial stiffness is perceived, and the overall comfort for the relaxed driver increases. Similarly, if the driving style is determined as aggressive while the speed of the vehicle 100 is considered high-speed or highway speed, control system 150 may control the steering actuator(s) 126 to provide less steering torque than an average assistive torque such that a large torque input provided by a driver yields a smaller rotational displacement of steering wheel 118 than during the average torque assistance. By providing less torque, higher artificial stiffness is perceived, and the perceived control and comfort for the aggressive driver increases. In some instances, control system 150 may control the steering actuator(s) 126 to decrease the steering torque to the extent that the steering torque is then applied an opposite direction from the average assistive torque such that the steering torque resists a driver's torque to increase the perceived or artificial stiffness. Particularly, the stiffness may be adjusted so that a driver perceives a pushing or pulling force back towards a center position of the steering wheel as the driver applies a torque to move the steering wheel away from the center position.

The driving style of a driver may further be used by control system 150 to improve advanced driver assist systems (ADAS) control modes for semi-autonomous steering operations of vehicle 100. For instance, control system 150 may be configured to operate vehicle 100 in any of the non-autonomous to semi-autonomous levels defined by the U.S. National Highway Traffic Safety Administration and the Society of Automotive Engineers for defining the degree of control exercised by control system 150 to drive vehicle 100. Level 0 has no automation, and the human driver makes all driving-related decisions; Level 1 is a semi-autonomous mode and includes some driver assistance, such as cruise control; Level 2 includes autonomous control of certain driving operations; Level 3 includes conditional automation that allows a human driver to selectively take control; and Level 4 is a highly automated mode in which the vehicle 100 is drivable without human assistance in certain conditions.

Typically, ADAS control modes of control system 150 may be configured to semi-autonomously control operations of various components of vehicle 100. For instance, during an ADAS control mode, control system 150 may be configured to control the direction and/or speed of vehicle 100 by controlling the motor system 110, transmission system 112, steering system 114, and braking system 116 (e.g., via computing device(s) 152). For instance, autonomous computing device(s) 152 may navigate vehicle 100 using data from a navigation system 164, positioning system 166, and/or driving assistance sensor(s) 168 to help navigate vehicle 100 to a destination. Driving assistance sensor(s) 168 (e.g., cameras) may be mounted on vehicle 100 (e.g., on lateral sides, on a forward end, and/or on a rearward end of vehicle 100) and be configured to generate data indicative of a distance between vehicle 100 and obstacles such as vehicles in adjacent lanes, a lane markers or boundaries, road debris, potholes and/or the like.

While driving during normal ADAS control mode conditions, control system 150 may selectively accelerate vehicle 100 (e.g., by throttling or energizing motor system 110), selectively decelerate vehicle 100 (e.g., by throttling motor system 110, changing gears within transmission system 112, and/or actuating braking system 116), and change the direction of travel for vehicle 100 (e.g., by turning the front wheels 101 of vehicle 100 with steering system 114) based on the inputs from the navigation system 164, positioning system 166, and/or driving assistance sensor(s) 168.

For instance, during a lane-keeping assist (LKA) mode, if is determined that vehicle 100 is beginning to approach a lane boundary, control system 150 may control steering actuator(s) 126 to provide guiding torque to steering shaft 124 to steer vehicle 100 away from the impending lane boundary. In some embodiments, there are two or more lines of engagement that are parallel to the lane boundary, where each line of engagement is spaced a different distance from the lane boundary. As vehicle 100 crosses line of engagement that are increasing closer to the lane boundary, control system 150 may be configured to apply a larger guiding torque to steering shaft 124 to steer vehicle 100 more strongly away from the impending lane boundary. Control system 150 may additionally, or alternatively, adjust the guiding torque applied to steering shaft in response to vehicle 100 approaching a lane boundary based at least in part on the driving style of the driver. For instance, is some embodiments, the guiding torque applied to steering shaft in response to vehicle 100 approaching a lane boundary is greater when the driving style of the driver of vehicle 100 is aggressive than when the driving style of the driver of vehicle 100 is relaxed. Alternatively, in some embodiments, the guiding torque applied to steering shaft in response to vehicle 100 approaching a lane boundary is lower when the driving style of the driver of vehicle 100 is aggressive than when the driving style of the driver of vehicle 100 is relaxed. The perceived stiffness may be adjusted once the driver begins to apply a torque in response to the guiding torque. For example, as indicated above, the perceived stiffness may further be adjusted such that the driver perceives a greater stiffness (e.g., acting towards a center position of the steering wheel) when the driver has an aggressive driving style or such that the driver perceives a lower stiffness when the driver has a relaxed driving style.

Similarly, during a lane-centering control (LCC) mode, associated with a higher level of autonomy than LKA, control system 150 may control steering actuator(s) 126 to provide guiding torque to steering shaft 124 to steer vehicle towards a center of a lane (e.g., a mid-point between detected lane boundaries or a set distance away from a detected lane boundary). As vehicle 100 veers away from the center of a lane, control system 150 may be configured to apply a larger guiding torque to steering shaft 124 to steer vehicle 100 towards the lane center. Control system 150 may additionally, or alternatively, adjust the guiding torque applied to steering shaft in response to vehicle 100 moving away from the lane center based at least in part on the driving style of the driver. For instance, is some embodiments, the guiding torque applied to steering shaft in response to vehicle 100 moving away from the lane center is greater when the driving style of the driver of vehicle 100 is aggressive than when the driving style of the driver of vehicle 100 is relaxed. Alternatively, in some embodiments, the guiding torque applied to steering shaft in response to vehicle 100 moving away from the lane center is lower when the driving style of the driver of vehicle 100 is aggressive than when the driving style of the driver of vehicle 100 is relaxed. Again, the perceived stiffness may be adjusted once the driver begins to apply a torque in response to the guiding torque. For example, as indicated above, the perceived stiffness may further be adjusted such that the driver perceives a greater stiffness (e.g., acting towards a center position of the steering wheel) when the driver has an aggressive driving style or such that the driver perceives a lower stiffness when the driver has a relaxed driving style. In some embodiments, control system 150 may disable the LCC mode if it is determined that the driver is distracted (e.g., if the driver has removed all points of contact from the wheel, is re-adjusting too frequently, etc.) to force a driver to re-focus their attentions on driving.

It should be appreciated that control system 150 may also include a wireless communication system 170 that assists with wireless communication with other systems. For instance, control system 150 may wirelessly connect control system 150 with one or more other vehicles, buildings, etc. directly or via a communication network. Wireless communication system 170 may include an antenna and a chipset configured to communicate according to one or more wireless communication protocols, such as Bluetooth, communication protocols described in IEEE 802.11, GSM, CDMA, UMTS, EV-DO, WiMAX, LTE, Zigbee, dedicated short range communications (DSRC), radio frequency identification (RFID) communications, etc. It should be appreciated that the internal communication between the computing device(s) 152 and the system(s) 110, 112, 114, 116 and sensor(s) 120, 128, 130 within vehicle 100 may be wired and/or wireless.

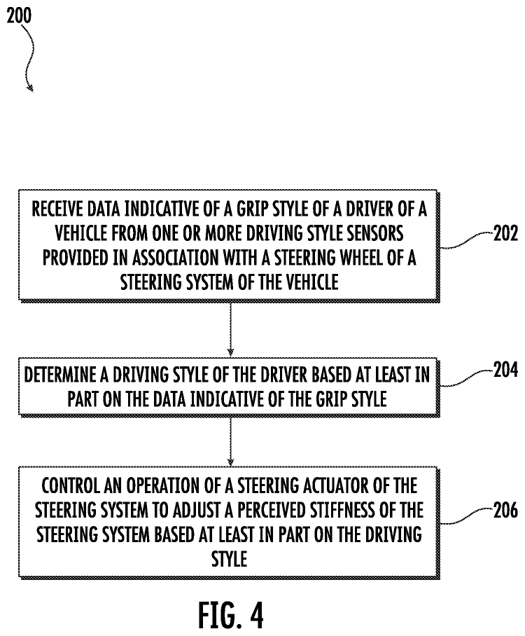

Referring now to FIG. 4, a flow diagram of one embodiment of a method 200 for controlling steering torque of a steering system of a vehicle is illustrated. In general, method 200 will be described herein with reference to vehicle 100 described with reference to FIG. 1, steering system 114 described with reference to FIG. 2, and control system 150 described with reference to FIG. 3. However, it should be appreciated that the disclosed method 200 may be used with any other suitable vehicle, steering system, and/or control system. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (202), method 200 includes receiving data indicative of a grip style of a driver of a vehicle from one or more driving style sensors provided in association with a steering wheel of a steering system of the vehicle. For instance, as described above, control system 150 may receive data indicative of a grip style of a driver of vehicle 100 from the driving style sensor(s) 130 provided in association with steering wheel 118 of steering system 114. The data indicative of the grip style may include a number of points of contact between the driver and steering wheel 118, the position of the points of contact on steering wheel 118, and/or a grip force applied by the driver on steering wheel 118.

Further, at (204), method 200 includes determining a driving style of the driver based at least in part on the data indicative of the grip style. For instance, as discussed above, control system 150 may be configured to determine that the driving style of the driver is a relaxed driving style or an aggressive driving style based at least in part on the data indicative of the grip style.

Additionally, at (206), method 200 includes controlling an operation of a steering actuator of the steering system to adjust a perceived stiffness of the steering system based at least in part on the driving style. For example, as described above, control system 150 may be configured to control an operation of the steering actuator 126 to adjust the steering torque applied to steering shaft 124 by steering actuator 126, where the steering torque is associated with a particular stiffness of the steering wheel perceived by the driver. For instance, control system 150 may be configured to control the steering actuator 126 to increase the steering torque to reduce the perceived stiffness when the driving style is a relaxed driving style and to decrease the steering torque to increase the perceived stiffness when the driving style is an aggressive driving style.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

### LIST OF REFERENCE CHARACTERS

100 Commercial vehicle
101 Wheels
102 Tractor
104 Trailer
110 Motor system
112 Transmission system
114 Steering system
116 Braking system
120 Speed sensors
122 Steering gear
124 Steering shaft
126 Steering actuator(s)
128 Shaft sensor(s)
130 Driving style sensor(s)
150 Control system
152 Computing devices
154 Processors
156 Memories
158 Instructions
160 Data
164 Navigation system
166 Positioning system
168 Lane sensor(s)
170 Wireless communications system
200 Method
FDOT Forward direction of travel
LG Longitudinal direction
LT Lateral direction
A1 Steering axis

What is claimed is:

1. A system for controlling steering torque of a steering system of a vehicle, the system comprising:
a steering wheel;
a steering shaft rotatably fixed to the steering wheel, wherein rotation of the steering shaft causes rotation of wheels of the vehicle about a steering axis;
a steering actuator controllable to apply a steering torque to the steering shaft, the steering torque being associated with a perceived stiffness;
one or more driving style sensors provided in association with the steering wheel, the driving style sensors configured to generate data indicative of a grip style of a driver on the steering wheel; and
a computing device communicatively coupled to the one or more driving style sensors and the steering actuator, the computing device being configured to determine a driving style of the driver based at least in part on the data generated by the one or more driving style sensors and to control an operation of the steering actuator to adjust the perceived stiffness based at least in part on the driving style.

2. The system of claim 1, wherein the data generated by the one or more driving style sensors indicates at least one of a number of contact points between the driver and the steering wheel, a position of the contact points between the driver and the steering wheel, or a grip force applied by the driver on the steering wheel.

3. The system of claim 2, wherein determining the driving style of the driver comprises determining that:
the driving style is relaxed based at least in part on at least one of the number of contact points being less than two, the position of the contact points being below a middle of the steering wheel, or the grip force being less than a grip force threshold, and
the driving style is aggressive based at least in part on at least one of the number of contact points being equal to or greater than two, the position of the contact points being at or above the middle of the steering wheel, or the grip force being equal to or greater than the grip force threshold.

4. The system of claim 2, wherein determining the driving style of the driver comprises applying the at least one of the number of contact points, the position of the contact points, or the grip force applied by the driver on the steering wheel to one or more algorithms.

5. The system of claim 1, further comprising one or more shaft sensors configured to generate data indicative of at least one of a total torque applied to the steering shaft or an angular displacement of the steering shaft,
wherein determining the driving style of the driver comprises determining the driving style of the driver based at least in part on the data generated by the one or more driving style sensors and the data generated by the one or more shaft sensors.

6. The system of claim 1, wherein controlling the operation of the steering actuator to adjust the perceived stiffness based at least in part on the driving style comprises controlling the operation of the steering actuator to increase the steering torque to above an average assistive torque when the driving style is relaxed and controlling the operation of the steering actuator to decrease the steering torque to below the average assistive torque when the driving style is aggressive.

7. The system of claim 1, further comprising at least one driving assistance sensor configured to generate data indicative of a position of the vehicle relative to a lane boundary,
wherein the computing device is communicatively coupled to the at least one driving assistance sensor, the computing device being further configured to automatically control the operation of the steering actuator to adjust a guiding torque applied by the steering actuator on the steering shaft based at least in part on the position of the vehicle relative to the lane boundary and the driving style.

8. The system of claim 7, wherein automatically controlling the operation of the steering actuator based at least in part on the position of the vehicle relative to the lane boundary and the driving style comprises controlling the operation of the steering actuator to decrease the guiding torque when the driving style is a relaxed driving style and to increase the guiding torque when the driving style is an aggressive driving style.

9. The system of claim 1, wherein the one or more driving style sensors comprises one or more pressure transducers on the steering wheel, the one or more pressure transducers being configured to generate an electrical signal proportional to a grip force applied to the steering wheel.

10. The system of claim 1, further comprising a speed sensor configured to generate data indicative of a speed of the vehicle, the computing device being configured to control the operation of the operation of the steering actuator to adjust the perceived stiffness based at least in part on the driving style when the speed of the vehicle exceeds a speed threshold.

11. A method for controlling steering torque of a steering system of a vehicle, the steering system comprising a steering wheel, a steering shaft rotatably fixed to the steering wheel, and a steering actuator controllable to apply a steering torque to the steering shaft, the steering torque being associated with a perceived stiffness, the method comprising:
receiving, by one or more computing devices, data indicative of a grip style of a driver from one or more driving style sensors provided in association with the steering wheel;
determining, by the one or more computing devices, a driving style of the driver based at least in part on the data indicative of the grip style; and
controlling, by the one or more computing devices, an operation of the steering actuator to adjust the perceived stiffness based at least in part on the driving style.

12. The method of claim 11, wherein the data from the one or more driving style sensors indicates at least one of a number of contact points between the driver and the steering wheel, a position of the contact points between the driver and the steering wheel, or a grip force applied by the driver on the steering wheel.

13. The method of claim 12, wherein determining the driving style of the driver comprises determining that:
the driving style is relaxed based at least in part on at least one of the number of contact points being less than two, the position of the contact points being below a middle of the steering wheel, or the grip force being less than a grip force threshold, and
the driving style is aggressive based at least in part on at least one of the number of contact points being equal to or greater than two, the position of the contact points being at or above the middle of the steering wheel, or the grip force being equal to or greater than the grip force threshold.

14. The method of claim 12, wherein determining the driving style of the driver comprises applying the at least one of the number of contact points, the position of the contact points, or the grip force applied by the driver on the steering wheel to one or more algorithms.

15. The method of claim 11, wherein the steering system further comprises one or more shaft sensors configured to generate data indicative of at least one of a total torque applied to the steering shaft or an angular displacement of the steering shaft,
wherein determining the driving style of the driver comprises determining the driving style of the driver based at least in part on the data generated by the one or more driving style sensors and the data generated by the one or more shaft sensors.

16. The method of claim 11, wherein controlling the operation of the steering actuator to adjust the perceived stiffness based at least in part on the driving style comprises controlling the operation of the steering actuator to increase the steering torque to above an average assistive torque when the driving style is relaxed and controlling the operation of the steering actuator to decrease the steering torque to below the average assistive torque when the driving style is aggressive.

17. The method of claim 11, wherein the steering system further comprises at least one driving assistance sensor configured to generate data indicative of a position of the vehicle relative to a lane boundary,
wherein the method further comprises automatically controlling the operation of the steering actuator to adjust a guiding torque applied by the steering actuator on the steering shaft based at least in part on the position of the vehicle relative to the lane boundary and the driving style.

18. The method of claim 17, wherein automatically controlling the operation of the steering actuator based at least in part on the position of the vehicle relative to the lane boundary and the driving style comprises controlling the operation of the steering actuator to decrease the guiding torque when the driving style is a relaxed driving style and to increase the guiding torque when the driving style is an aggressive driving style.

19. The method of claim 11, wherein the one or more driving style sensors comprises one or more pressure transducers on the steering wheel, the one or more pressure transducers being configured to generate an electrical signal proportional to a grip force applied to the steering wheel.

20. The method of claim 11, further comprising receiving, by the one or more computing devices, data indicative of a speed of the vehicle,
wherein controlling the operation of the steering actuator to adjust the perceived stiffness based at least in part on the driving style comprises controlling the operation of the steering actuator to adjust the perceived stiffness based at least in part on the driving style when the speed of the vehicle exceeds a speed threshold.
